(19) United States
(12) Patent Application Publication
(10) Pub. No.: US 2026/0286969 A1
(43) Pub. Date: Sep. 24, 2026

(54) A VACUUM PUMP AND A PERMANENT MAGNETIC BEARING ASSEMBLY FOR A VACUUM PUMP

(71) Applicant: Edwards Limited, Burgess Hill, Sussex (GB)

(72) Inventor: Emiliano Lucchetta, Burgess Hill, Sussex (GB)

(21) Appl. No.: 19/490,201

(22) PCT Filed: May 17, 2024
(86) PCT No.: PCT/GB2024/051289

§ 371 Date: Dec. 4, 2025

(30) Foreign Application Priority Data
Jun. 8, 2023 (GB) 2308522.8

(51) Int. Cl. F04D 29/058; F04D 19/04; F16C 32/04

(52) U.S. Cl. CPC F04D 29/058; F04D 19/042; F16C 32/0425; F16C 2204/60; F16C 2208/00; F16C 2360/45

(57) ABSTRACT

A passive magnetic bearing assembly for a vacuum pump and a vacuum pump having such a bearing are disclosed. The passive magnetic bearing assembly has a plurality of pairs of ring magnets arranged in a stack, a ring magnet of a pair being arranged on a stator side of the bearing and the other magnet of the pair being arranged on a rotor side. The ring magnets are radially magnetised, and each rotor ring magnet comprises at least a first harmonic of magnetic inhomogeneity, where magnetic inhomogeneity is measured as the ratio between the 0-peak variation of remanence ΔBᵢ and the average remanence B_{R0}, that is less than 3%.

### CROSS-REFERENCE TO RELATED APPLICATION

This application is a Section 371 National Stage Application of International Application No. PCT/GB2024/051289, filed May 17, 2024, and published as WO 2024/252125 A1 on Dec. 12, 2024, the contents of which is hereby incorporated by reference in its entirety and which claims priority of British Application No. 2308522.8, filed Jun. 8, 2023.

### FIELD

The field of the invention relates to vacuum pumps and to permanent magnetic bearing assemblies for such pumps.

### BACKGROUND

Vacuum pumps such as turbomolecular pumps may have rotors mounted on magnetic bearings to reduce friction and contamination from lubricant.

Generally permanent magnetic bearings PMBs in these pumps are made using axially magnetised arrays. FIG. 1 schematically shows such a bearing. In some applications, such as scanning electron microscopes SEM, transmitting electron microscopes TEM and ion traps the stray magnetic field arising from the magnetic bearing can be a problem. There are two types of stray magnetic field in magnetic bearings, the AC stray field is the time varying magnetic field generated during rotation, that is due mainly to magnetisation errors in the magnets of the bearing, and the DC stray field that is the time invarying intrinsic magnetic field generated by the magnets. FIG. 2 schematically shows the AC and DC fields of a magnetic bearing. While FIG. 3 shows two types of magnetisation errors, the global skew and inhomogeneity, in the case of axially magnetised ring magnets.

Conventionally the AC stray magnetic field has been reduced in magnetic bearings either by selectively aligning them (see for example EP2705263) or by correcting the magnetisation errors of each magnet. Such techniques are time consuming and can increase cost. Although such techniques address the problem of AC stray magnetic field, axially magnetised magnets, and thus PMBs built using them, have an intrinsically high DC stray magnetic field, which is more difficult to address.

It would be desirable to provide a PMB with both a low DC and AC stray magnetic field. Additionally, a design not requiring selective assembly/alignment or rectification of magnetisation errors would be advantageous.

The discussion above is merely provided for general background information and is not intended to be used as an aid in determining the scope of the claimed subject matter. The claimed subject matter is not limited to implementations that solve any or all disadvantages noted in the background.

### SUMMARY

An aspect provides a passive magnetic bearing assembly for a vacuum pump, said passive magnetic bearing assembly comprising: a plurality of pairs of ring magnets arranged in a stack, a ring magnet of a pair being arranged on a stator side of the bearing and the other magnet of the pair being arranged on a rotor side; said ring magnets are radially magnetised, and each ring magnet on said rotor side comprises at least a first harmonic of magnetic inhomogeneity, wherein inhomogeneity is measured as the ratio between the 0-peak variation of remanence ΔBᵢ and the average remanence B_{R0}, and wherein for at least the majority of the ring magnets on the rotor side, and preferably for all of those ring magnets, the first harmonic of magnetic inhomogeneity is less than 3%.

It is important in some applications for magnetic bearings to have low stray magnetic field. DC stray magnetic field is the intrinsic magnetic field created by the magnets in the surrounding space. It was recognised by the inventor that radially magnetised ring magnets have naturally low DC stray fields, much lower than axially magnetised ring magnets. Additionally, it was recognised that a pair of stator and rotor radially magnetised ring magnets—the building block of a radially magnetised PMB—has an even lower DC stray field compared to the same pair built with axially magnetised ring magnets. However, AC stray fields are more difficult to manage with radially magnetised bearings as processes such as selective alignment are particularly difficult with such magnets due to the attraction between neighbouring magnets. The inventor recognised not only that stray DC fields are low with radially magnetised magnets, but also that if magnets with a low inhomogeneity are used on the rotor side then the AC stray field is also manageable. Additionally, the inventor recognised that the sensitivity of an AC magnetic stray field to inhomogeneity is also dependent upon the shape of the inhomogeneity around the circumference of the magnet and is greatest for the first order harmonics and decreases rapidly for higher order harmonics. This is particularly so where the field is measured at a distance from the magnets, for examples outside a vacuum pump's stator at positions where attaining a low AC Stray field is particularly important.

The inhomogeneity of a magnet is caused by variation of its remanence BR in its volume, where the remanence is a property of the magnet and is the magnetic flux density that remains after an external field is removed.

The inhomogeneity may be specified as the ratio of the 0-peak variation of the remanence ΔBᵢ to the average remanence B_{R0}. Inhomogeneity can be determined by measuring the radial flux density of the magnetic field generated by the magnet in the space surrounding the magnet. The average remanence is determined by averaging the radial flux density measured at the same set distance from the magnet around the outer circumference, after removing any background magnetic field, for example the earth's magnetic field.

By measuring the amplitude of the radial flux density for any given harmonic, the corresponding inhomogeneity harmonics can be determined. Thus, magnets for the rotor side with low first and second harmonic magnetic inhomogeneities are selected to provide a low AC and DC stray field.

Highly homogeneous magnets are increasingly available and providing a magnetic bearing with radially magnetised magnets, where the rotor magnets are highly homogeneous radially magnetised magnets is an effective way of reducing both AC and DC stray fields while still providing an effective magnetic bearing.

In some embodiments the stator magnets may also be highly homogeneous radially magnetised magnets and in some embodiments they may have the same or similar requirements on inhomogeneity as the rotor magnets. Although the problem of AC stray magnetic field only arises with rotating magnets, it can be advantageous for the stator magnets in the bearing to be highly homogeneous too, for example to reduce bearing eccentricity caused by magnetisation errors.

Although a first harmonic inhomogeneity of less than 3% may provide an effective bearing, one where both the first and second harmonics are less than 3% for at least the majority, and preferably all, of the ring magnets on the rotor side may be preferable.

In some embodiments, a first and in some cases a second harmonic of less than 2% or preferably less than 1% may be provided for at least the majority, and preferably all, of the ring magnets on the rotor side.

In some embodiments, at least some of said ring magnets comprise NdFeB magnets. In some embodiments all of said rotor ring magnets and in some embodiments all of said magnets comprise NdFeB magnets.

NdFeB magnets have a high performance, and with high homogeneity may make particularly effective magnets for a radially magnetised passive magnetic bearing assembly. NdFeB magnets may contain other elements beside Nd, Fe and B. For example, praseodymium may be added as a replacement for neodymium in variable quantities. Other elements may include one or more of Dy, Ga, Co, Al and Cu.

In some embodiments, at least some of said ring magnets comprise hot deformed NdFeB magnets. In some embodiments, all of said rotor ring magnets, and in some cases all of said stator ring magnets too, comprise hot deformed NdFeB magnets.

Some NdFeB magnets that are hot deformed can provide particularly homogeneous magnets and are thus, particularly effective at providing a low AC field.

With hot deformed radially magnetised NdFeb magnets, the attractive forces are high making assembly, and especially selective alignment more difficult. However, non-magnetic shims in between the magnets can be used to reduce the attractive forces with only a negligible/modest loss of bearing stiffness for the thickness required.

Radially magnetised magnets can be made in plastic bonded magnets, for example in Smco, NdFeB, SmFeN or a mixture thereof.

In some embodiments, at least some of said ring magnets comprise hot deformed NdFeB without any Heavy Rare Earth Element (‘HREE free’) having minimum intrinsic coercivity at 20° C.>1400 kA/m.

HREE, such as Dysprosium (and/or others elements, for example Terbium) is often used in magnetic materials to help retain their magnetism and by extension to improve their high temperature performance. Hot deformed NdFeB magnets may have a high coercivity even without HREE such as dysprosium, making them a particularly good choice for some PMB applications. HREE are expensive elements which are not easy to source and for which there may be ethical considerations in their sourcing, therefore finding magnets with no or reduced dysprosium content and that still have a reasonable coercivity has advantages.

In some embodiments, at least some of said ring magnets comprise hot deformed NdFeB with a HREE content of <3%, said HREE being non grain boundary diffused within said magnet and said ring magnets having a minimum intrinsic coercivity at 20° C.>1700 kA/m. In some embodiment, where gain boundary diffusion of HREE is used, the HREE content is less than <1.5% with minimum intrinsic coercivity at 20° C.>1700 kA/m.

In other embodiments, magnets with a low HREE content may be used and these may have a higher coercivity and may be more effective in certain applications. The grain boundary diffused nature of the HREE has been found to provide effective temperature protection with the HREE being present in reduced amounts.

In other embodiments, the magnets may comprise PrFeB magnets.

In some embodiments, said magnets comprise plastic bonded magnets.

Radially magnetised magnets can be made in plastic bonded magnets, for example in Smco, NdFeB, SmFeN or a mixture thereof.

Another way of forming magnets with low inhomogeneities is to use plastic bonding to form the magnets. Plastic bonded magnets can be manufactured to have desired properties by control of the manufacturing process and may provide magnets that are particularly applicable for forming radially magnetised passive magnetic bearings having low inhomogeneities.

In some embodiments, the bearing assembly further comprises non-magnetic shims, said non-magnetic shims being arranged to axially separate said ring magnets in said stack.

As noted previously, radially magnetised magnets attract each other making them difficult to selectively align to further reduce the AC magnetic field. Although, using magnets with low inhomogeneities reduces the AC field to some extent, this can be further reduced with selective alignment. Neighbouring radially magnetised magnets are difficult to align as they are strongly attracted to each other. This is a particular problem with hot deformed radially magnetised NdFeB magnets, the attractive forces being high and making assembly, and especially selective alignment more difficult. However, non-magnetic shims, defined as materials where the relative permeability is less than 1.1, placed in between the magnets can be used to reduce the attractive forces with only a negligible/modest loss of bearing stiffness for the thickness required.

In some embodiments, shims with a low coefficient of friction on at least some of their outer surface are preferred to facilitate angular alignment between magnets.

In some embodiments, the shims are made in polymer or a fibre reinforced polymer, for example PEEK or, for example, Torlon.

In some cases, the low coefficient of friction may be provided by the shim's material in other cases by a low friction coating.

A further aspect provides a vacuum pump comprising a passive magnetic bearing according to a first aspect said vacuum pump comprising a rotor rotatably mounted within a stator, a ring magnet of each pair being mounted to said rotor and the other ring magnet of the pair being mounted to said stator.

In some embodiments said vacuum pump comprises a turbomolecular pump.

In some embodiments, said rotor ring magnets are selectively aligned to reduce the stray AC field.

In some embodiments, said ring magnets are selectively vertically orientated to reduce the stray DC field.

In addition to reducing the stray AC field by selectively aligning the rotor ring magnets, the stray DC field may also be addressed by selectively vertically orientating the stator and rotor ring magnets such that magnets with a small, undesired component of magnetisation in the axial direction, can be arranged in opposite orientations so that the axial fields point in different directions and the overall magnetic stray DC field is reduced.

In some embodiments, the magnets may be selected so that they have similar levels of undesired component of magnetisation in the axial direction, such that by appropriate orientation the global sum of the DC field is particularly low.

A yet further aspect provides a method of manufacture of a passive magnetic bearing assembly according to a first aspect, said method comprising: measuring the inhomogeneity of at least a first harmonic of a plurality of radially magnetised rotor ring magnets by: determining a radial component of magnetic flux density harmonics at a set distance from said rotor ring magnets measured at different points around its circumference; and calculating said inhomogeneity of at least a first harmonic by dividing the magnetic flux harmonics' 0-peak amplitude by said average flux; selecting said rotor ring magnets where for at least the majority, and preferably all, of the ring magnets for the rotor said calculated inhomogeneity of at least said first harmonic is below a threshold value; and stacking said selected rotor ring magnets and a corresponding set of stator ring magnets to form said passive magnetic bearing assembly.

In some embodiments it is the first and second harmonics that are measured and both the first and second harmonic inhomogeneities should be below the threshold value.

In some embodiments, the plurality of radially magnetised rotor ring magnets for which the steps of measuring the inhomogeneity are performed are a subset of a batch of ring magnets to be used to form the PMBs, a statistical analysis of the results being used to determine whether further rotor ring magnets from the batch should be tested or whether the whole batch of ring magnets may be selected to form passive magnetic bearing assemblies.

Although the rotor ring magnets are those that contribute to the AC stray field, it may be advantageous for the stator ring magnets to be matched to the rotor ones and thus, testing and selecting them in the same way may have advantages.

In some embodiments, said step of stacking includes a step of separating said ring magnets in said stacks with non-magnetic shims.

In some embodiments, said step of determining the magnetic flux comprises determining the amplitude and relative phase of components of flux density of different harmonics and said step of stacking comprises aligning said ring magnets so total variations in flux around the circumference for a stack of said magnets are reduced for the different harmonics, for example for the first and second harmonics.

The total variations in flux around the circumference may comprise the vectorial sum for the flux density for different harmonics.

In some embodiments, the magnets forming an array are selected according to the magnitude of their inhomogeneity harmonics (and/or measured magnetic flux density) such that when suitably aligned they compensate for each other and provide a very low AC stray magnetic field.

In some embodiments, the method further comprises determining any unintended component of magnetisation in the axial direction of each ring magnet by measuring said axial DC field at a set distance from said ring magnet and said step of stacking said magnets comprises orientating said ring magnets in the stack to reduce the total axial DC field for said magnetic bearing assembly. In some embodiments, the magnets forming an array are also selected according to the magnitude of the unintended component of magnetisation in the axial direction such that when orientated appropriately the axial components will substantially cancel each other out and provide a very low DC stray magnetic field.

In some embodiments, rather than determining the unintended axial components of magnetisation for all magnets, only a subset of the ring magnets are measured for this property. These measurements are used in a statistical quality analysis to confirm the high homogeneity and low component of axial magnetisation in the ring magnets, and only where the statistical analysis shows a lower than expected quality of magnets are more measurements made.

In some embodiments, the stray field of the PMB and in particular, the AC stray field is tested after assembly of the PMB rotating half or after full assembly of the pump when the pump or PMB is rotating at given speeds, to determine whether the stray magnetic field is beneath a predefined threshold. In some cases all of the pumps/PMBs may be tested, while in other cases, only a subset are tested and a statistical analysis of the results is used to determine whether pumps are meeting the desired requirement or require further testing or improvement.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

The summary is provided to introduce a selection of concepts in a simplified form that are further described in the detailed description. This summary is not intended to identify key features or essential features of the claimed subject matter, nor is it intended to be used as an aid in determining the scope of the claimed subject matter.

### BRIEF DESCRIPTION OF THE DRAWINGS

Embodiments of the present invention will now be described further, with reference to the accompanying drawings, in which:

FIG. 1 schematically shows an axially magnetised passive magnetic bearing assembly;

FIG. 2 schematically shows AC and DC stray magnetic fields arising from a rotating axially magnetised PMB;

FIG. 3 schematically illustrates, global skew and inhomogeneities in an axially magnetised ring magnet;

FIG. 4 schematically shows a magnetised passive magnetic bearing assembly according to an embodiment;

FIG. 5 schematically shows the DC field emitted by a radial and axially magnetised ring magnet at a radial distance of 100 mm;

FIG. 6 schematically illustrates, global skew and inhomogeneities in a radially magnetised ring magnet;

FIG. 7 shows an example of the first and second inhomogeneity harmonics in a ring magnet

FIG. 8 schematically shows a portion of a vacuum pump according to an embodiment;

FIG. 9 schematically shows a portion of a magnetic bearing assembly according to an embodiment;

FIG. 10 shows the axial stiffness for different shim thicknesses of a bearing according to an embodiment; and

FIG. 11 shows a flow chart schematically illustrating steps in a method according to an embodiment.

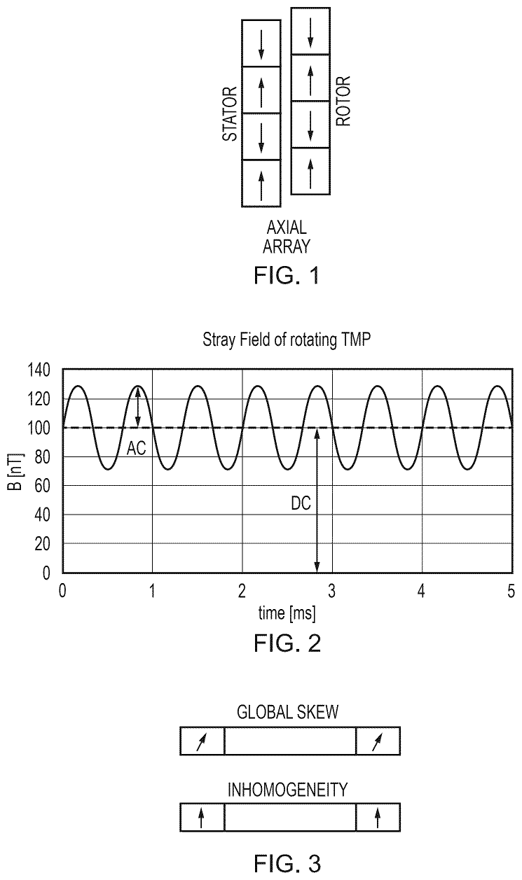

### DETAILED DESCRIPTION

Before discussing the embodiments in any more detail, first an overview will be provided.

Passive magnetic bearings for vacuum pumps are conventionally made using axially magnetised ring magnets. Advantages of axially magnetised ring magnets include easy magnetisation and assembly and multiple materials possible for forming the magnets. Disadvantages include an intrinsically high DC stray field and a requirement of selective alignment or correction to reduce the AC stray field.

Radially magnetised arrays, are more difficult to magnetise and assemble, there are fewer materials available for making them and they have comparable stiffness to corresponding axially magnetised arrays. However, they do have an intrinsically low DC stray field. A low DC stray field is particularly important in some applications such as ion traps and TEMs.

Bearings made with axially magnetised magnet rings are very sensitive to skew and less so to inhomogeneities, while bearings made with radially magnetised magnet rings are much more sensitive to a lack of homogeneity. The AC field can be reduced by selective alignment of the different rings. However, in a radially aligned bearing this is more difficult than in an axially aligned bearing as the rings attract each other.

Passive magnetic bearings that use radially magnetised magnet arrays may provide a reduced leakage time invariant or DC stray magnetic field. Furthermore, the time varying or AC stray magnetic field generated during rotation may also be reduced provided that at least rotor magnets with a required level of homogeneity are used. The use of high coercivity HREE or Dysprosium (‘Dy’) free or low HREE or Dy NdFeB magnetic alloys in radially magnetised magnets made by hot deformation process, results in a material with a very fine crystalline structure that is very uniformly oriented in the radial direction, and therefore a very homogenous magnetisation, making the AC stray field much lower.

A further way of reducing the AC field may be to use selective alignment of the magnets, so that the AC field from one magnet compensates for the AC field from another. In a radially magnetised array this can be problematic due to the strong attraction between neighbouring magnets. The use of non-magnetic shims interposed between adjacent layers of magnet pairs may be used to reduce the attractive forces making the assembly and selective alignment of the magnets easier. The magnets may be selected with similar levels of inhomogeneity so that the compensation between magnets with appropriate alignment is effective.

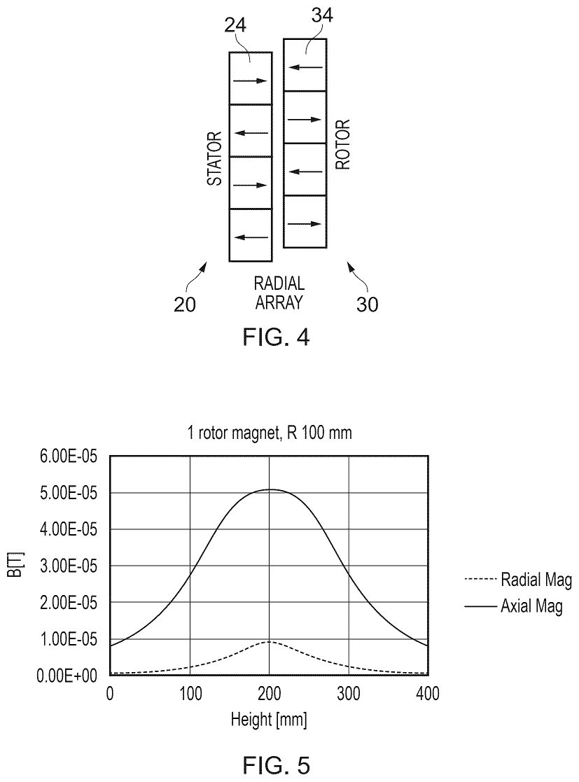

FIG. 4 schematically shows a radially magnetised PMB according to an embodiment. It shows a cross section through one side of the bearing assembly showing the stator side of the bearing assembly 20 and the rotor side of the bearing assembly 40. The rotor side is made up of a stack of ring magnets 24 while the rotor side is made up of a stack of ring magnets 34. The direction of magnetisation is shown by the arrows.

FIG. 5 schematically shows the DC field emitted by a radially and axially magnetised ring magnet at a distance of 100 mm and as can be seen the DC field for the axially magnetised ring magnet is far higher than that for the radially magnetised ring magnet. As noted previously the DC field is the time invarying intrinsic magnetic field in the space surrounding the magnet while the AC field is due to magnetisation errors, with radially magnetised magnets being very sensitive to homogeneity and not sensitive to global skew. Thus, were radial rotor magnets with low inhomogeneities to be sourced a PMB with both low AC and DC stray fields could be made.

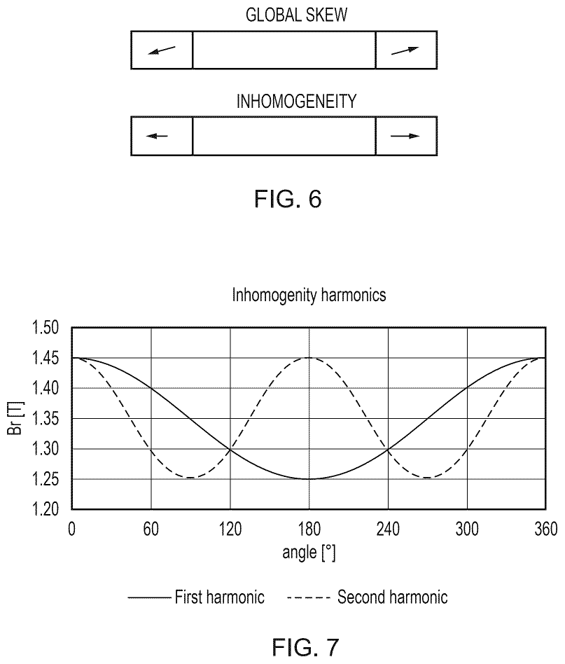

FIG. 6 schematically shows global skew and inhomogeneities in radially magnetised ring magnets.

FIG. 7 shows the first and second harmonics of inhomogeneity in a ring magnet. The remanence of both harmonics is plotted versus the circumferential angle of the ring. For both harmonics the 0-peak amplitude ΔBi is 0.1 T, whereas the average remanence Bro is 1.35 T, thus the inhomogeneity is 0.1/1.35=0.074 (7.4%). Thus, such a magnet would not be suitable for a rotor of a PMB according to an embodiment.

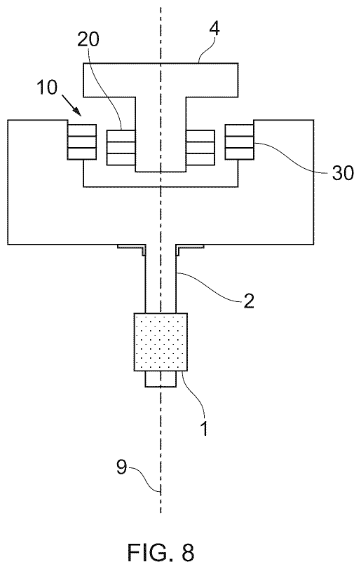

FIG. 8 schematically shows a vacuum pump comprising a passive magnetic bearing 10 according to an embodiment. PMB 10 comprises a stack of rotor magnets 30 and a stack of stator magnets 20 that form either side of the passive magnetic bearing. The stator bearing magnets 20 are mounted on stator 4 while the rotor bearing magnets are mounted on the rotor portion with shaft 2. The pump further comprises a motor 1 mounted on the shaft 2 for rotating the shaft about an axis.

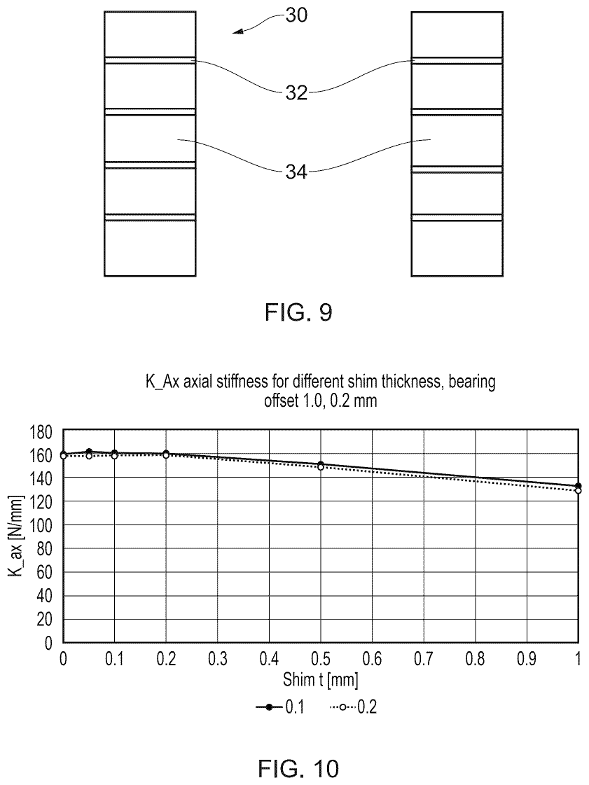

FIG. 9 schematically shows a cross section through a stack of ring magnets 34 that may form the rotor portion 30 or the stator portion of a passive magnetic bearing. In this embodiment there are non-magnetic shims 32 between each magnet 34. This allows the magnets to be more easily stacked and rotated to selectively align them to further reduce the AC field if required. One potential problem with shims is that it may reduce the axial stiffness of the bearing. In some embodiments these shims are made of plastic materials, while in others they may be non-magnetic metals. Plastic materials are easier to manufacture, may have a low coefficient of friction, making alignment easier, but may not be as stiff or robust as a metal shim. Preferred plastic materials may include fibre reinforced PEEK.

FIG. 10 shows the axial stiffness for different shim thicknesses and how the axial stiffness reduces with shim thickness. As can be seen shims of small thickness do not make too big a difference to the axial stiffness of the magnet array.

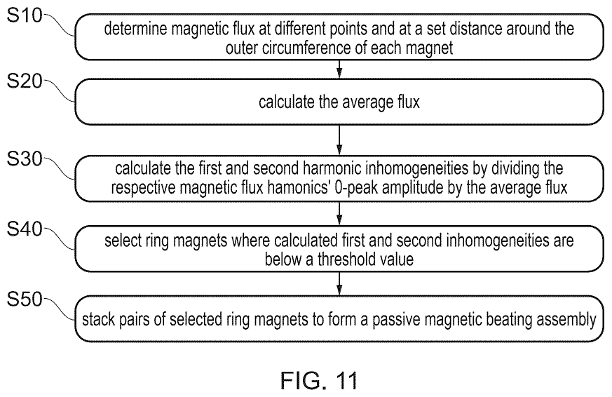

FIG. 11 shows steps of a method according to an embodiment. In an initial step at S10 the magnetic flux at different points and at a set distance around the circumference of a plurality of ring magnets is determined. At step S20 the average flux from these measurements is found. At step S30 the first and second harmonic inhomogeneities of the different ring magnets is calculated, the inhomogeneity being evaluated using the respective harmonic 0-peak flux density amplitude, and dividing this by the average flux around the circumference, the latter after substantially removing the background magnetic field. This inhomogeneity is defined as ΔBi/Br₀.

The background field may be removed by measuring the background field and then subtracting the measured field from the measured values. Alternatively, shielding may be used to reduce/eliminate the background field, or the background field may be reduced/or even eliminated by generating an opposing field with a set of coils.

The step of measuring the magnetic flux S10 may involve a magnetic probe measuring a component of the magnetic flux density, for example Brad AC [0-pk] and DC around the magnet at a given radius R, typically with R>rₒ (outer r of magnet). The measurements are performed with the probe axis located in the plane perpendicular to the magnet's axis and cutting the magnet in 2 equal parts (‘z=0). The harmonics of the flux density can be calculated or can be the direct output of the measuring equipment, if the measurement equipment contains processing circuitry performing for example a Fast Fourier Transform or an Order Spectrum.

For a given harmonic of ΔBi/Br₀, the ratio Brad [o-pk]/Brad [DC] ratio will depend on magnet size and the position where the magnetic flux density if measured.

Coefficients can be calculated or determined experimentally to allow determination of inhomogeneity of the ring magnet for each harmonic from the measurement of flux density around its circumference. In practice Brad DC changes little between different magnets of set material & geometry meaning that measuring the AC magnetic flux component, Brad [0-pk] for example, only may be sufficient.

The 0-pk magnitudes of different 0-pk harmonics can be measured together with the respective phases relative to a reference position on the magnet if required; these measurements can be carried out as quality controls but also to provide the information required to selectively align magnets to attain even lower AC fields where this step is performed.

In addition to Brad 0-pk, the axial flux density Bz 0-pk (and phase) of harmonics can also optionally be measured with the same setup, to ensure the field created by the global skew error is negligible as a quality control, or if needed to provide the information required to selectively align the magnet if so required to attain even lower AC fields.

At step S40 the ring magnets where the calculated first and second harmonic inhomogeneities that are below a threshold value are selected and then at S50 pairs of selected ring magnets are stacked to form a passive magnetic bearing assembly according to an embodiment.

In some embodiments, rather than performing steps S10 to S30 for each magnet, a subset of magnets may be measured and used in a statistical quality analysis, and only where the number not having the require homogeneity rises above a threshold value are measurements of further ring magnets performed.

In some embodiments a further step of determining the stray field of the assembled passive magnetic is performed, with the bearing rotating at a given speed to check that it is below a desired threshold. Alternatively and/or additionally the stray field due to the assembled bearing within an operational vacuum pump rotating at full speed may be tested to determine that this is below a desired threshold. As for the testing of the magnets, this may be done on each bearing or pump, or it may be done as a statistical analysis, where a subset are tested and only if failure rate is able a particular level are further tests performed.

In some embodiments, non-magnetic shims may be placed between the magnets as they are stacked and in some embodiments the ring magnets may be selectively aligned to reduce the global AC field by aligning portions of each magnet such that the minimum flux density harmonic(s) of one coincides with the maximum flux of another. In some embodiments the DC field may be reduced by orientating the magnets so that the magnetic field density axial component of the magnets array, including that generated by unwanted magnetisation component in the axial direction, is minimised, cancelled or at least reduced.

The unwanted component of the axial magnetisation in the axial direction may be determined using the same setup as used for determining the inhomogeneity. With the same setup (z=0), Bz DC can also be measured at a set distance from the magnet's centre. For a perfectly radially magnetised magnet, at z=0 Bz DC=0 once background (i.e. earth's) magnetic field has been subtracted. If this is non-zero, an axial magnetisation component could be present, which would result in an increased DC magnetic field. Therefore, if a very low DC field is required, the magnets in a stack can be orientated (in the sense of flipping them upside down or vice versa) as well as selectively assembled to create a particularly low DC field array.

A summary and examples of the sensitivity of stray fields with differently magnetised ring magnets, radially and axially magnetised, to different magnetisation errors—global skew and inhomogeneity—are provided below.

Global skew can be quantified by the misalignment angle between the actual magnetisation direction and the intended direction. Inhomogeneity of magnetisation can be quantified by the ratio between the 0-peak variation of remanence ΔBᵢ and the average remanence B_{R0} for different harmonics. In a ring magnet for example, the equation below describes the first harmonic of the remanence of the magnet bearing around its circumference.

B_{R}=B_{R0}+ΔBᵢ cos θ (1)

The stray field variation around a magnet with a given geometry when the magnet is magnetised radially and axially can be assessed by calculating the stray field variation at a given distance from the magnet centreline and a given height z above the plane containing the magnet, and cutting the magnet in half.

In the case of inhomogeneity, the sensitivity can be calculated as the ratio between different components (e.g. radial, axial, tangential) of AC stray field amplitude ΔB and the remanence 0-peak variation ΔBᵢ, as defined by Equation 1 above. In the case of skew, the sensitivity can be calculated as the ratio between the different components AC of stray field amplitude ΔB and the skew angle in degrees.

Table 1 and Table 2 show the results for an example of radially and axially magnetised magnets of a given geometry for a representative distance R from the magnets centreline.

TABLE 1
sensitivities for radially magnetised ring magnets.

| Inhomogeneity, Radial Magn. | | | | Skew, Radial Magn | | | |
|---|---|---|---|---|---|---|---|
| | ΔB/ΔBi [nT/T o-pk] | | | | ΔB/°[nT/° o-pk] | | |
| z [mm] | Brad | Bϑ | Bz | z [mm] | Brad | Bϑ | Bz |
| 0 | 4706 | 2343 | 0 | 0 | 0.1 | 0.04 | 9.9 |
| 50 | 3903 | 2137 | 1529 | 50 | 7.9 | 2.1 | 6.0 |
| 100 | 2329 | 1670 | 2021 | 100 | 8.5 | 2.8 | 0.04 |

TABLE 2
sensitivities for axially magnetised ring magnets.

| Inhomogeneity, Axial Magn. | | | | Skew, Axial Magn | | | |
|---|---|---|---|---|---|---|---|
| | ΔB/ΔBi [nT/T o-pk] | | | | ΔB/°[nT/° o-pk] | | |
| z [mm] | Brad | Bϑ | Bz | z [mm] | Brad | Bϑ | Bz |
| 0 | 0 | 0 | 421 | 0 | 221 | 110 | 0 |
| 50 | 336 | 90 | 254 | 50 | 184 | 101 | 72 |
| 100 | 360 | 120 | 1 | 100 | 110 | 79 | 95 |

The results show that the arrays with radially magnetised magnets are much less sensitive to global skew, which is good. Conversely, they are more affected by inhomogeneity. Therefore, in order to reduce the AC magnetic stray field from radially magnetised magnets, it is important to have a very high homogeneity of the magnetisation.

For radially magnetised ring magnets, the sensitivity of AC magnetic stray field to inhomogeneity changes with the shape of the inhomogeneity around the circumference in the magnet and is greatest for the first harmonics and decreases rapidly for higher order harmonics, especially when the field is measured not in very close proximity to the magnets, for examples outside a vacuum pump's stator at positions where attaining a low AC Stray field is important.

The sensitivity to different harmonics can be demonstrated by calculating the amplitude of radial flux density harmonics generated by harmonics of inhomogeneity of the same magnitude.

Table 3 shows the results of the calculations for the first four harmonics, for z=0 as in the previous example, and at three different radii R1<R2<R3.

TABLE 3
AC stray field sensitivity to different harmonics of inhomogeneity
(Brad o-pk)/(Brad 0-peak for first harmonic)

| Harmonic | R1 | R2 | R3 |
|---|---|---|---|
| 1 | 1 | 1 | 1 |
| 2 | 0.512 | 0.266 | 0.134 |
| 3 | 0.200 | 0.053 | 0.013 |
| 4 | 0.069 | 0.009 | 0.001 |

Therefore, magnet rings with low first and second order harmonic inhomogeneity are particularly suited for these designs.

As far as plastic bonded magnets are concerned, the homogeneity of the magnetisation is determined mainly by the homogeneity of the magnetic powders inside the plastic matrix, especially for magnets produced with isotropic powders.

Thus, in order to minimise or at least reduce the AC stray field the flow and final density of the powders must be controlled very accurately. Compression moulded magnets may have typically a higher homogeneity than injection moulded magnets.

When the powders are anisotropic, the homogeneity of the magnetisation will also be controlled by the orientation of the powders during, for example, the injection moulding process.

In some cases plastic bonded magnets may have low strength, as defined by their BHmax product, resulting in low stiffness for the bearing, and their use as PMBs in fast rotating pumps such as turbomolecular pumps is therefore not widespread.

Of more interest for these faster rotating pumps are the PMB made with sintered magnets; for axially magnetised magnets sintered NdFeB for example.

Sintered NdFeB magnets are magnetically very strong, with high BHmax products, and PMB can attain a high stiffness.

Radially magnetised NdFeB magnet rings are produced with a different process from sintering, where the magnetic orientation of the material is not imparted by an external magnetic field, instead the orientation is imparted by thermo-mechanical action. Therefore the material is referred to as ‘hot deformed’ NdFeB instead of sintered, although the materials are very similar in terms of physical (e.g. density) and magnetic properties (e.g. BHmax product).

Radially magnetised NdFeB magnet rings can be obtained from different sources in different grades, defined by the magnetic strength of the material (BHmax product) and resistance to temperature. The resistance to temperature is generally increased by adding and/or increasing the content of Dysprosium. The higher the content of Dy, the higher the intrinsic coercivity Hcj and thus the resistance to demagnetisation; magnets with no or low amounts of Dysprosium have Hcj typically below 1000 kA/m.

Where pumps such as turbomolecular pumps operate at temperatures below or at 120° C. max, a minimum Hcj of typically 1400 kA/m, is preferable to prevent extensive demagnetisation during assembly and during use. This might require a content in dysprosium of approximately 3% (or about half of that if grain boundary diffusion techniques are used), which corresponds to the standard grade H for such magnets. Higher coercivity may be required depending on the application, 1600 kA/m corresponding to the SH grade, or sometimes about 2000 kA/m corresponding to the UH grade for others, with a Dysprosium content of about 9%.

Tests have shown that the magnetic AC stray field generated by hot deformed NdFeB magnets may be higher than desired. The results confirm that inhomogeneity for the first order harmonics is the biggest contributor to AC stray field with a value—exceeding 4% ΔBi/Bro for the first harmonic.

The resulting AC stray field from each magnet is such that selective alignment may be required to keep the total AC stray field from a PMB below the limits required for critical applications.

However, the effort to significantly reduce or eliminate the use of Dysprosium, an element in great demand and in short supply, whilst maintaining a high intrinsic coercivity and therefore ability to operate at sufficiently high temperatures, has motivated an in-depth research in how the process parameters in hot deformed magnets manufacturing can be tuned to obtain such a material.

Dy-free material with high coercivity can be obtained by reducing the hot deformation temperature in the manufacturing process as described in Technical publication ‘High performance hot deformed NdFeB magnets’ by Dr. K. Hioki. Dy free material with magnetic strength comparable to that of the normal grade tested with an intrinsic coercivity of 1500 kA/m or higher, whilst the typical intrinsic coercivity of the Dy free NdFeB is just below 1000 kA/m.

The resulting material is a full density nanocrystalline material with the highest level of radial orientation leading to higher homogeneity, and when tested radially magnetised ring magnets, made with Dy free materials, with high intrinsic coercivity provide a magnetic stray field that is lower than standard hot deformed NdFeB. The typical homogeneity of the magnetisation is ~2% ΔBi/Bro or lower for the first harmonics as determined from the measurements available on the website of such magnets' suppliers.

The use of these magnets in a PMB made using radially magnetised magnets allows a low stray AC field to be obtained in conjunction with a very low stray DC field without the need for the selective alignment of magnets. If selective alignment of magnets is used, even lower AC stray field PMBS can be obtained.

Equally, hot-deformed Nd—Fe—B magnets using similar process parameters, and having a Dy content<3% and a minimum intrinsic coercivity at 20° C. is >1700 kA/m can be obtained, whereas for standard hot deformed NdFeB material with the comparable Dy composition it is <1400 kA/m.

These low dysprosium high heat resistance materials can be used to the same effect.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A passive magnetic bearing assembly for a vacuum pump, said passive magnetic bearing assembly comprising:
a plurality of pairs of ring magnets arranged in a stack, a ring magnet of a pair being arranged on a stator side of the bearing and the other magnet of the pair being arranged on a rotor side;
said ring magnets are radially magnetised, and each ring magnet on said rotor side comprises at least a first harmonic of magnetic inhomogeneity, wherein inhomogeneity is measured as the ratio between the 0-peak variation of remanence ΔBᵢ and the average remanence B_{R0}, and wherein for at least the majority of the ring magnets on the rotor side the first harmonic of magnetic inhomogeneity is less than 3%.

2. The passive magnetic bearing according to claim 1, wherein, for at least the majority of the ring magnets on said rotor side, each of the first and second harmonics of magnetic inhomogeneity is less than 3%.

3. The passive magnetic bearing assembly according to claim 2, wherein, for at least for the majority of the ring magnets on said rotor side, each of said first and second harmonics of said magnetic inhomogeneity is less than 2%.

4. The passive magnetic bearing assembly according to claim 2, wherein for at least the majority of the ring magnets on said rotor side, each of said first and second harmonics of said magnetic inhomogeneity is less than 1%.

5. The passive magnetic bearing assembly according to claim 1, wherein each ring magnet on said stator side comprises at least a first harmonic of magnetic inhomogeneity, wherein inhomogeneity is measured as the ratio between the 0-peak variation of remanence ΔBᵢ and the average remanence B_{R0}, wherein, for at least the majority of the ring magnets on the stator side, the first harmonic of magnetic inhomogeneity is less than 3%.

6. The passive magnetic bearing assembly according to claim 1, wherein at least some of said ring magnets comprise NdFeB magnets.

7. The passive magnetic bearing assembly according to claim 6, wherein at least some of said ring magnets comprise hot deformed NdFeB magnets.

8. The passive magnetic bearing assembly according to claim 1, wherein said magnets comprise plastic bonded magnets.

9. The passive magnetic bearing assembly according to claim 1, further comprising non-magnetic shims, said non-magnetic shims being arranged to axially separate said ring magnets in said stack.

10. The passive magnetic bearing assembly according to claim 9, wherein said non-magnetic shims are formed of a material with a low coefficient of friction on the faces contacting the magnets.

11. The passive magnetic bearing assembly according to claim 9, wherein said non-magnetic shims are formed of a plastic material.

12. A vacuum pump comprising a passive magnetic bearing assembly according to claim 1, said vacuum pump comprising a rotor rotatably mounted within a stator, a ring magnet of each pair being mounted to said rotor and the other ring magnet of the pair being mounted to said stator.

13. The vacuum pump according to claim 12, wherein said vacuum pump comprises a turbomolecular pump.

14. The vacuum pump according to claim 12, wherein said ring magnets are selectively aligned to reduce the stray AC field and wherein said magnets comprise plastic bonded magnets.

15. The vacuum pump according to claim 12, wherein said ring magnets are selectively vertically orientated to reduce the stray DC field.

16. A method of manufacture of a passive magnetic bearing assembly according to claim 1, said method comprising:
measuring at least the first harmonic inhomogeneity of a plurality of radially magnetised rotor ring magnets by:
determining magnetic radial flux density at a set distance from said magnet rings measured at different points around its circumference; and
calculating at least the first harmonic inhomogeneity by dividing the respective magnetic flux harmonics' 0-peak amplitude by the average flux around the circumference after removing radial flux density of background field;
selecting said ring magnets for said rotor where, for at least the majority of the ring magnets for the rotor, the first harmonic of magnetic inhomogeneity is said calculated at least a first harmonic inhomogeneity is below a threshold value; and
stacking said selected rotor ring magnets with a corresponding set of stator ring magnets to form said passive magnetic bearing assembly.

17. The method according to claim 16, wherein said step of stacking includes a step of separating said ring magnets in said stacks with non-magnetic shims.

18. The method according to claim 16, wherein said step of determining the magnetic flux comprises determining the magnitude and phase of flux density harmonics and said step of stacking comprises aligning and, optionally, selecting said ring magnets so total variations in flux density harmonics around the circumference for a stack of said magnets are reduced.

19. The method according to claim 18, further comprising determining the axial DC field of each ring magnet by measuring said field at an axial distance from said ring magnet and said step of stacking said magnets comprises orientating and, optionally, selecting said ring magnets in the stack to reduce the total axial DC field for said magnetic bearing assembly.
